(19) United States
(12) Patent Application Publication
(10) Pub. No.: US 2006/0161463 A1
(43) Pub. Date: Jul. 20, 2006

(54) Method and system for in-process tracking of an operation

(76) Inventors: John Poonnen, Chapel Hill, NC (US); Mark M. Zanecki, Chapel Hill, NC (US); James C. Carenzo, Apex, NC (US); Evan M. Lew, Philadelphia, PA (US)

Correspondence Address: KILPATRICK STOCKTON LLP, 1001 WEST FOURTH STREET, WINSTON-SALEM, NC, 27101, US

(21) Appl. No.: 11/222,620

(22) Filed: Sep. 9, 2005

Related U.S. Application Data
(60) Provisional application No. 60/608,316, filed on Sep. 9, 2004.
(60) Provisional application No. 60/615,494, filed on Oct. 1, 2004.

(51) Int. Cl. G06Q 40/00; G06F 17/30

(52) U.S. Cl. 705/4; 707/10

(57) ABSTRACT

A method and system for capturing, monitoring, tracking, displaying, and/or reporting events and discrete information during an operation to enable managers to better understand and manage the in-process activities of the operation. Data derived from events and discrete information from heterogeneous applications is used to populate a central database which communicates with other databases that contain information pertinent to the operation. The central database is queried through a user interface for obtaining in-process information during the operation.

### CROSS-REFERENCE TO RELATED APPLICATIONS

This application claims priority to U.S. Provisional Patent Application Ser. No. 60/608,316, filed Sep. 9, 2004, titled “Insurance Claims Inventory,” and U.S. Provisional Patent Application Ser. No. 60/615,494, filed Oct. 1, 2004, titled “Data Analysis,” the entirety of both applications is hereby incorporated by reference.

### FIELD OF THE INVENTION

The present invention relates generally to methods and systems for tracking information during a process. Embodiments of methods and systems of the present invention permit tracking of information so that, by way of example, corrective actions and expediting of processing through escalation of fault conditions is enhanced and enabled at all stages. More particularly, but not by way of limitation, the present invention relates to methods, systems, computer readable media, special calculations and user interfaces for managing and processing insurance claims, and providing data useful in determining the unpaid claims liability for received but unprocessed claims on a continuous basis.

### BACKGROUND OF THE INVENTION

Many individuals are covered by one or more types of insurance including, for example, life insurance, disability insurance, vehicle insurance, property insurance, casualty insurance, health insurance, and the like. In industrialized countries a large portion of the population is covered by government, or privately managed healthcare insurance. Healthcare providers, including physicians, dentists, chiropractors, optometrists, and the like, often obtain payment for medical services provided to a patient from an insurer, which is generally a healthcare organization or insurance company administering a plan for the patient or the patient's employer. In other instances, healthcare and/or health service providers are paid directly by a patient and the patient is reimbursed by a healthcare organization or insurance company.

The growth and expansion of insurance coverage has resulted in the handling of millions of claims by the health insurance industry. Each claim being the most important claim in the system to the healthcare provider, insured or patient submitting the claim.

In order to obtain payment for a claim, a healthcare provider and/or insured provides information to the insurance company relating to the service provided, thereby making a “claim” for payment. An industry-standard paper or electronic claim form may be filled out by the healthcare provider. The claim provides information required by the payer for payment to the healthcare provider for the service rendered to a patient. The information may include identifying information about the healthcare provider and patient, a service identification code, the patient's group and plan number, payer identification, the amount of the claim, co-payment amount, and the like.

The claim is processed by the insurance company for payment. During processing, the claim may go through multiple changes, including transformations, validations, financial processing, reductions, reversals, sortings, translations and the like, from receipt to final disposition. Often with traditional methods and systems, details about a claim are not known during the processing and the changes that the claim undergoes are lost entirely. These details are of utmost importance to various efficiencies and effectiveness measures of a claims processing organization, especially as they relate to promptness of service, detection of fraudulent activity, correctness of claim adjudication and regulatory compliance.

Many claim processing systems are assembled using discrete software applications and manual steps for managing or processing tasks. The software applications are specialized for the task they are asked to perform and include application specific databases for maintaining data related to a claim and to processing of a claim. Prior processing systems lack the means to determine the status or state of a claim without querying each software application's database to determine residency of the claim data within the database. For example, each application database may use different terminology and definitions at the point of receipt and disposition. In prior systems, the status and state of a claim was generally only available at the point of initial receipt and/or overall disposition, i.e., was a claim in the system and/or had the claim been paid or denied. Further details regarding claim status or state needed to be determined by querying specific software applications and/or databases within the claims processing system. A comprehensive view was only available by manually assembling the data received from a query. This was onerous and detracted from the streamlining of claims handling operations. Once a claim was located in a software application database, information about the claim needed to be gathered from individuals responsible for processing the claim at that step in the process who understood the terminology and definitions of the process.

Further, insurance companies, such as healthcare insurers, set aside reserves to cover the cost of claims that have been received but not yet processed. Traditional methods and systems for monitoring claim processing provide minimal information useful in the estimating the unpaid claims liability (UCL) which can have a detrimental impact on the company's financial stability and profitability.

The deficiencies in traditional methods and systems are attributed, in part, to the way claims are processed for adjudication and payment. As discussed above, adjudication and payment are usually conducted by disparate claims processing systems that apply different methods and rules to classify, bundle or split a claim that enters these systems. The integrity of the originating claim data is compromised and a claim's status is not easily determined or traceable through the claims processing systems. Moreover, there is not a uniform claims identifier that uniquely identifies a claim across these systems.

Accordingly, it would be advantageous to have improved systems and methods for use by insurers to manage and track claims from receipt to final disposition. It would also be advantageous to have improved systems and methods for tracking events, and/or locating discrete items, and displaying information relating to processes generally. Further, it would be advantageous to have data that enables more accurate estimates of unpaid claims liability.

### SUMMARY OF THE INVENTION

The present invention provides systems, methods and computer readable media for capturing; monitoring; tracking; measuring; influencing; anticipating; and/or reporting events, discrete information and/or items during the entire end-to-end claims process. In an embodiment, status and/or state of events and/or items may be determined, as may the virtual or physical location of information (data) and/or discrete items within the process. Embodiments of the present invention are advantageous for administering and managing processes, including for example, validations, transformations, financials, and the like; and for gaining insight into the flow of discrete items within a process. Further embodiments of the present invention are advantageous for displaying information relating to administering and managing processes as described above.

A method of the present invention may be advantageously utilized in a system. A system of the present invention may comprise computer hardware and software sufficient for carrying out a method of the present invention. The software may comprise software for managing events, for example in a message based infrastructure. Computer readable media of the present invention may be computer readable media comprising program code for implementing a step of a method of the present invention.

An embodiment of the present invention provides a method for tracking events and/or the virtual or “physical” location of discrete claim information during insurance claims processing. A further embodiment enhances the accuracy of the unpaid claims data useful in a determination of unpaid claims liability for insurance claims that have been received but may have not have completed processing and/or have been paid. As explained in more detail below an insurance claim may undergo many processing steps prior to approval for payment, or disapproval.

An embodiment of the present invention provides a method, or a system, for capturing and maintaining data relating to claims processing in a single virtual location. As will be appreciated by those of ordinary skill in the art, by so doing, an embodiment of the present invention allows data relating to a claim to be more easily “found”, used and/or analyzed.

An embodiment of the present invention provides a method, or a system, for capturing and maintaining data relating to claims processing in a common format. The common format facilitates the construction and use of value added engines for using and/or analyzing the claim data.

As will be appreciated by those of ordinary skill in the art, the maintaining of data in a single location and/or in a common format provides many advantages to users and managers of the data and/or process generating the data.

A feature of an embodiment of the present invention is the persistence of data. Data captured is maintained (persists) in the form it is captured. For example, captured claim data from a submitted claim is maintained thereby enabling the submitted claim to be recreated after processing. Transformations that occur during processing of a claim may be also be recreated and evaluated after they occur as “before” and “after” data is maintained. The persistent data also facilitates an ability to create virtual representations of the claim at different points during processing. Such ability can be advantageous for auditing and in other contexts.

An embodiment of the present invention takes an end-to-end view of the claims process by capturing attributes from in-process claims and completed claims. The embodiment captures data on various “events” (e.g., date paper claims received) that claims pass through to eventual final completed state, which includes: receipt, routing and loading of claims; and adjudication and pricing of claims. An embodiment of the present invention provides those who manage a part of the claims process with the ability to monitor any single claim or collection of claims as they pass through the various “events” from receipt through a final completed state. The monitoring of claims includes inventory management, escalation mechanisms, alerting mechanisms and process performance measurement.

As used herein, inventory management refers to the tracking of unprocessed claims and the monitoring of claims “submitted” on an ongoing basis with trending and analysis intents.

Escalation as used herein refers to the hierarchical triggering of alerts to users, for example users at supervisory levels, informing them of alert conditions that have not been addressed within specified timeframes. Escalation mechanisms refers to the use of escalation methods personalized or suitable for the current situation. Examples of escalation mechanisms include, but are not limited to automatic triggering of messages to supervisors after a predefined period and broadcasting of messages to designated levels of operational support through multiple means (email, pager, phone).

Alerting mechanisms refers to the system of generation of messages to designated operational support staff as soon as a specific condition occurs. Examples of alerting mechanisms include, but are not limited to descriptive or terse messages regarding identified actionable conditions sent via pager, email, phone, voicemail and console displays to responsible operational support staff.

Process performance measurement may use analytics and analytical tools used to gauge process performance. Process performance can include hold times, backlogs, processing queue size and similar variables.

An embodiment of the invention provides managers with the capability to track, balance and report on any claim, or collection of claims, at any point of the claim's life cycle from receipt to final completed state. Real-time linkages of analytics to transactional data is also provided to improve outcomes associated with the claims process. In a further embodiment, there is full integration of front-end data and event-based triggering that permit prospective, or concurrent, interventions that enable such value-added activities as prospective fraud identification and prevention, “flagging” claim submission anomalies, and identifying and addressing catastrophic health events or potential for the same early in the cycle, or for early detection and handling of recognized patterns leading to the same..

In another embodiment of the present invention, the method and system provides data that supports the claims analysis and risk assessment activity to accurately determine the dollar liability amount and claim counts for claims received but not processed, for monthly reserve valuation purposes. The method and system may improve the accuracy of unpaid claims liability reserve estimates by allowing incorporation of a more accurate value of unpaid claims in processing into the algorithm(s) used for calculating unpaid claims liability reserves. Increased accuracy and reliability of claims status data enables better pricing and facilitates timely decision-making on claim liability trends, thus affecting pricing.

An embodiment of the present invention captures all claims data as they are submitted as the “external view” of the claim as it was received from the submitter. The present invention maintains the integrity of the original claims data to enable re-creation of the original claim from “submitted” data sources rather than trying to reconstruct the claim after it is has been processed and adjudicated. The external view of the claim is then matched to the claim payment data created by claims processing systems, such as PowerMHS and LRSP. Claims that are matched to the external inventory of claims are considered paid and those that remain are unpaid. The value of unpaid inventory may be directly quantified and used to determine the UCL estimate through actuarial methods.

In an embodiment, the central database is a single source of the integrated end-to-end view of claims, with all data stored once and only once, with derived value-added fields determined from the appropriate systems of record for “submitted” and “completed” claims stages. In a further embodiment, continuous loading of claims from various claims data sources provides a “real-time” view of all claims processes across the enterprise. As described in more detail below, the central database may also be used to capture data from third party processing of claims.

“Submitted” claims data is used for analysis requiring information on claims submitted and where the primary goal is to see the raw form of the claim, along with any modifications and to access data as soon as possible, track and analyze inventory, and monitor status through routing, pre-processing and claims processing engines. “Submitted” claims are the source for determining claims liability from both unworked raw claims inventory and from claims that are currently “submitted”. “Submitted” claims data enables improved workflow planning and problem solving and assists in predicting operations workloads. “Submitted” claims information enables algorithms to be applied to prospectively divert claims with high fraud potential or other unfavorable anomalies for special handling or expediting/escalation. “Submitted” claims data can help ensure compliance with regulations such as those that require prompt payment of claims. In addition, prospective care management and the identification of patterns that indicate a path to catastrophic health events, from the moment the claim is received, can lead to successful intervention tactics.

The present invention provides advantageous means for tracking claims through processing that can be used, for example in real time, by managers and administrators to determine inventories, bottlenecks, physical and financial capacity and/or inefficiencies in claims processing such that resources may be applied or shifted to overcome the inefficiencies and future needs may be more accurately predicted. As a result, use of the present invention can advantageously improve insurance claims processing from the insurer's, insured's and/or payee's perspective.

A central database may receive information relating to each claim as the claim enters the claims processing system. In an embodiment, the information relating to each claim is created in a common format and the central database is populated with the information. The central database in an embodiment of the present invention may also communicate with another database(s) comprising information relating to the insured, the patient, the type of insurance, employer information, payee information, provider information and the like, such that fields in a data structure relating to a claim may be populated with information already contained in the insurer's files.

The central database communicates with each software application database regarding a claim in the software application database. Application program interfaces (“api's”) or service-oriented-architecture paragdigms may be utilized to facilitate the communication. Events occurring in claim processing within a software application, and between and among software applications, may be communicated to the central database. The communication between and among software applications and the central database may occur in real time, e.g., when an event happens, or may occur at specified intervals.

Population of the central database will allow the central database to be queried directly, and as a single source, for up-to-date information relating to the status and/or state of a claim. The central database may also be queried for the information relating to a business process metric regarding handling of the claim. Such information may provide management the ability to better allocate processing resources; identify productivity improvements within or external to business processes; and/or the need to enhance, replace and/or modify software applications. Such information may also provide management with better tools for managing the financial aspects of claims processing, including managing financial reserves and timely payment of claims.

The central database may also be populated with information relating to claims processed by third parties that are paid by an insurer. For example, in a health care insurance embodiment, claims relating to health care related services may be processed by an insurance provider wherein claims relating to prescription drug benefits, dental services, vision related services and/or mental health related services may be processed by a third party and paid by the insurance provider. In an embodiment of the present invention, the central database comprises data relating to third party processed claims. The data may comprise the data described herein with reference to claim adjudication and processing, or may comprise portions of such data, for example, the adjudicated claim value.

A further embodiment of the present invention uses the claims data inventory to determine, for example through a value added engine, an estimate of potential payments which is a method of determining the dollar liability amount and claim counts for claims received but not finally processed. In doing so, an embodiment of the present invention supports the actuarial data requirements for monthly reserve valuation purposes of an insurer's claims analysis and risk assessment activity. It should be noted that although reference is made to providing a solution for claims analysis and risk assessment, the present invention also provides solutions regarding claims throughput, claim processing operations, HIPAA compliance, and the coordination of benefits (COB).

An embodiment of the present invention solves the problems with traditional methods and systems by providing for a system and method that stores claim records, caputres claim payment data, and other accounting data from various claim processing systems (e.g., LRSP, MHS) and a general ledger system; and generates value-added fields of data vis-à-vis one or more value added engines (VAEs). The VAEs provide reports and/or generate certain value added fields of data based on business rules that are applied to the claims nd accounting data that are captured and stored in a central database.

A further embodiment of the present invention is a user interface for displaying information relating to a process. The present invention provides a user interface for displaying one or more of the following data relating to a process: the status of events, the state of events, the status of items, the state of items, the virtual location of items, and/or the physical location of items within the process.

The data display in an embodiment of the present invention may comprise an alphanumeric character, an icon, a graphical display, a chart and/or combinations thereof. Certain embodiments of the present invention feature the use of icons that provide analog representations whose meaning may be quickly determined by a user viewing the display.

Although the present invention has been described with reference to a healthcare insurance claim processing system, the present invention may be embodied in other ways and used with other processes. Embodiments of the present invention may be useful in industries or processes wherein source materials or data undergoes processing through disparate or heterogeneous application systems. For example, embodiments of the present invention may be useful in the processing of receivables, or payables other than insurance claims. Other embodiments of the present invention may be advantageously utilized in financial transaction processing. Still other embodiments of the present invention may be utilized with chemical or industrial processes.

The illustrative embodiments are mentioned not to limit or define the invention, but to provide examples to aid in the understanding thereof. Illustrative embodiments are discussed in the Detailed Description, and further description of the invention is provided there.

### BRIEF DESCRIPTION OF THE DRAWINGS

These and other features, aspects, and advantages of the present invention are better understood when the following Detailed Description is read with reference to the accompanying drawings, wherein:

FIG. 1 provides a schematic overview of the general architecture of an embodiment of the present invention.

FIG. 2 provides a schematic overview of a process in an embodiment of the present invention.

FIG. 3 provides a schematic overview of a process of an embodiment of the present invention.

FIG. 4 provides an illustration of a high level data flow for an embodiment of the invention.

FIG. 5 provides a illustration of data flows for a further embodiment of the present invention.

FIG. 6A illustrates a user interface display in an embodiment of the present invention.

FIG. 6B provides a larger view of a portion of the user interface display depicted in FIG. 6A.

FIG. 7 illustrates another form of user interface display in an embodiment of the present invention.

FIG. 8 illustrates a further form of user interface display in an embodiment of the present invention.

### DETAILED DESCRIPTION OF THE INVENTION

An embodiment the present invention provides systems, methods and computer readable media for capturing; monitoring; tracking; and/or reporting events, discrete information and/or items during a process. The features and advantages of the present invention are described in more detail in the following paragraphs, particularly with reference to an insurance claims process. As will be apparent to those of ordinary skill in the art from the following description, embodiments of the present invention may be advantageously utilized with other types of processes, and therefore the following paragraphs should not be viewed as limiting the scope or applicability of the present invention.

An insurance claim comprises information including a plurality of datum relating to one or more of the following: an insured, a patient, a provider of services to the insured benefits available to the insured, costs of services, a patient, a location of services, the diagnosis, the procedure, and the like. During processing of the claim a datum may validated, corrected, transformed, reduced, or otherwise modified several times. In an embodiment of the present invention, each of these actions on a datum may comprise an event. In general, an event may comprise: a time stamp, status (e.g. a change in status or a suspense), a location, a translation, a reduction, a separation, a validation, a sorting, a transformation, a change in a datum, and the like. An embodiment of a method of the present invention captures an event and populates a database with the event and optionally the initiator/trigger/operator of the process/event. The database is also populated with an identifying datum or information relating to the claim. The database may then be queried for information relating to an event or a claim. In an embodiment, a operational/transactional data structure is utilized within the central database to facilitate interaction with querying and/or report generating software.

The datum may comprise: a time datum; a status datum; an identification datum; a datum that the software application has received a claim; a datum that the software application has processed a claim; a datum that the software application has transformed a claim; a datum that the software application has validated a claim; a datum that the software application has corrected a claim; a datum that the software application is processing a claim; a datum that the software application has routed a claim to a different software application; a time stamp; a receipt datum; a processing datum; a distribution datum; a location datum; a transformation datum; a validation datum, a correction datum, a process or business metric datum and/or a datum relating to another event.

With respect to an embodiment of the present invention the terminology “transform”, “transformed”, “transformation” and the like have their accepted meaning within the art and refer to changing a datum. With respect to the present invention the terminology “validate”; “validated”, “validation” and the like have their accepted meaning within the art and refer to confirming the correctness of a datum. With respect to the present invention “correct”, “corrected”, “correction” and the like have their accepted meaning within the art and refer to changing a datum and validating the change.

Often an insurance claims processing system will utilize multiple software applications for performing steps in processing a claim. Examples of software applications include, but are not limited to, a paper to electronic claim conversion application; an enrollment verification application; an imaging application; a routing application; a HIPAA editing application; an insurer editing application; a suspense processing application; a financial application; an auditing application; a claim payment application; an adjudication application; and the like. An event may also comprise a receipt or transfer of a claim by, to or from a software application.

As will be appreciated by the description herein, the present invention may be utilized to monitor a process at a macro level, for example a process involving multiple software applications wherein the present invention is utilized to determine status of processing and efficacy of processing by each application. An embodiment of the present invention may also be utilized to monitor a process occurring within a single software application.

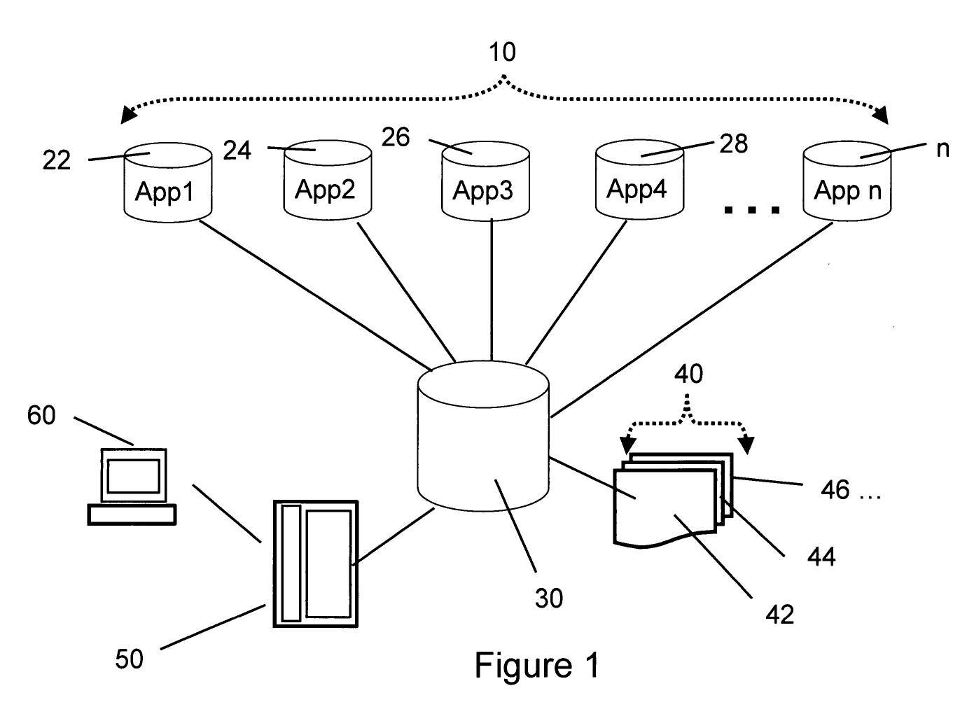

A possible architecture of an insurance claim processing system of the present invention is illustrated in FIG. 1. This type of embodiment of the present invention comprises computer software having instructions for implementing an embodiment of a method of the present invention. The instructions may comprise code from any computer-programming language, including, but not limited to, Ab Initio; Cobol; C, C++, C+, C#, Visual Basic, Java, Python, Perl, JavaScript and the like. The instructions may be used to structure the data in XML.

As shown in FIG. 1, a system may comprise a central database 30 comprising a data structure 40 including fields 42, 44 and 46. The data structure may include additional fields. The fields may correspond to specific events; information and/or items in a process.

The processing system may include a plurality of software applications App1, App2, App3, App4 through Appn. Application specific databases 22, 24, 26, 28 and n, corresponding to applications App1, App2, App3, App4, Appn in system 10 communicate with central database 30. Each application, App1-Appn may comprise a software application from the examples of software applications set forth above.

In an embodiment of the present invention a datum relating to an event, information and/or an item in processing of a claim is communicated to central database 30. The communication may be generated by the software application, e.g., App1, may be triggered by an event, and/or may be generated by a query from central database 30.

The central database 30 may reside on a server 50 having a processor and memory. Computing device 60 may interface with server 50 to provide a way to create input and view output from central database 30 and applications App1, App2, App3, App4, Appn, and application specific databases 22, 24, 26, 28 and n. Software applications App1-n may reside on server 50 or additional servers or computing devices. The software applications, server and computing devices may be interconnected by a local area network, a wide area network, and/or the Internet/world wide web.

The central database 30 may be queried to extract information relating to a claim. An embodiment of the present invention may comprise a reporting tool to extract and display information from the central database 30. The reporting tool may be implemented in computer software and in an embodiment that may utilize SQL instructions for displaying information from the central database 30 on computing device 60.

Server 50 and computing device 60 comprise a computer-readable medium, such as a random access memory (RAM) coupled to a processor. Server 50 and/or computing device 60, may also comprise storage. The processor executes computer-executable program instructions stored in memory and accesses information stored in storage. Such processors may comprise a microprocessor, an ASIC (application specific integrated circuit), and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C+, C#, Visual Basic, Java, Python, Perl, Ab Initio; Cobol and JavaScript.

Computing device 60 may also comprise a number of external or internal devices such as a mouse, a CD-ROM, DVD, a keyboard, a display, or other input or output devices. Examples of computing devices are personal computers, digital assistants, personal digital assistants, cellular phones, mobile phones, smart phones, pagers, digital tablets, laptop computers, Internet appliances, and other processor-based devices. In general, a computing device 60 may be any type of processor-based platform that is connectable to a network and that interacts with one or more application programs. Computing devices 60 may operate on any operating system capable of supporting a browser or browser-enabled application, or a reporting device, such as Microsoft® Windows® or Linux. The computing devices include, for example, personal computers executing a browser application program such as Microsoft Corporation's Internet Explorer™, Netscape Communication Corporation's Netscape Navigator™, and Apple Computer, Inc.'s Safari™.

Software applications and databases can communicate over a network with each other and with other systems and devices coupled to the network. Although server 50 is depicted as a single computer system, server 50 may be implemented as a network of computer processors. Examples of a server device 50 are servers, mainframe computers, networked computers, a processor-based device, and similar types of systems and devices. The processor in server 50 and computing device 60 can be any of a number of computer processors, such as processors from Intel Corporation of Santa Clara, Calif., NCR Corporation of Dayton, Ohio, AMD of Sunnyvale, Calif. and Motorola Corporation of Schaumburg, Ill.

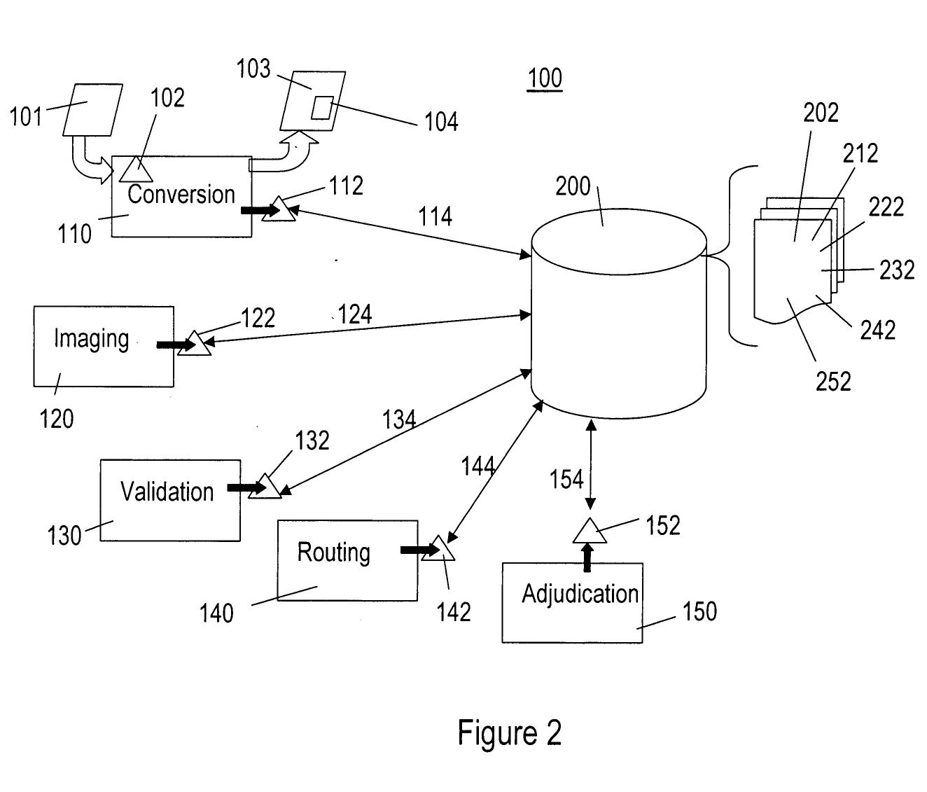

FIG. 2 provides a simplified schematic overview of a portion health insurance claims processing process. FIG. 2 and the accompanying description are set forth to provide a simplified overview of a possible embodiment of the present invention.

As shown in FIG. 2, a health insurance claims processing process 100, may comprise a plurality of processing steps, 110, 120, 130, 140 and 150 that may be implemented in separate software applications. Processing step 110 may comprise a conversion of a paper claim to electronic format. Processing step 120 may comprise a digital imaging of the claim. Processing step 130 may comprise validation of the claim. Processing step 140 may comprise routing of the claim. Processing step 150 may comprise adjudication of the claim. As will be understood by those of ordinary skill in the health insurance claims processing art, the foregoing process steps, while representative of the types of processing steps found in health insurance claims processing, are not a complete list of all the potential processing steps that a health insurance claim may undergo.

By way of illustration, a health insurance claim 101 may comprise information relating to the identification of the insured. In processing step 110, a field 104, of an electronically formatted claim 103, may be populated with a datum relating to the identification of the insured. For example, a datum may comprise an identification number. The population of field 104 in an electronically formatted claim may comprise an event 112. The occurrence of event 112 may trigger a communication 114 to a central database 200, and populate a field 212 of the database. The entrance of health insurance claim 101 may also comprise an event, 102 that is communicated (not shown in FIG. 2) to the central database 200 and populates a field 202 of the database. The contents of field 104 may be checked in processing steps 120, 130, 140 and 150, generating events, 122, 132, 142 and 152, and communications 124, 134, 144 and 154 that populate fields 222, 232, 242 and 252 in central database 200.

Central database 200 may be queried and the contents of each field reviewed. A query that reveals that fields 202, 212 and 222 are populated whereas fields 232, 242 and 252 are not populated, provides an indication that routing in processing step 140 has not begun.

It should be appreciated that the foregoing description of an embodiment of the present invention with reference to FIG. 2, and the techniques discussed for populating the central database, have been provided by way of example. The present invention, and the individual method steps that make up an embodiment of the present invention, may be implemented in multiple ways as should be appreciated from the description contained herein.

Additional features and advantages of the present invention are highlighted by the following example: In general, there are two methods by which providers or subscribers submit claims 1) sending a claim on paper or 2) sending a claim electronically. For each of these processing paths, claims pass through various detailed states that can be tracked.

When a claim arrives via paper, it is sorted and then scanned to capture an image. The paper claim generally arrives on a standard form and technology is used to optically read the hard copy, e.g., optical character recognition (OCR), and digitize it for electronic processing. The OCR technology attempts to automatically digitize the claim and when it fails, it is sent to a queue where a processor keys the claim data manually from the image that facilitates accurate and timely keying. The foregoing processing is often achieved through a single or set of systems called imaging and scanning. The digitized claim then is routed to the same processes as an electronic claim.

If a provider, subscriber or clearing house elects to send a claim electronically, they generally have a multitude of methods to transmit the claim. The claim often is sent in batches with control records to verify that all the claims in a batch arrived successfully. Submitters send claims or two main types 1) Professional and 2) Institutional. By Federal Law, electronic claims must be submitted per HIPAA specifications The claims go through a validation to ensure they comply with these HIPAA rules. If they fail, they are rejected. If they pass a variety of validation steps, they are transformed to optimal formats that internal systems utilize. The claims are sent to additional business validation steps. After additional business validation steps, the claims are examined for business line codes to determine routing to the correct claims adjudication system. Once it arrives to the correct claims system, it will undergo a more specific editing process looking at the full context of the claim including prior claims, service codes, location of service, and diagnose codes. Claims can be suspended or held for further processing.

When claims are suspended or require additional processing, the claim can be assigned a reason code. The claim also can be automatically routed using intelligence workflow to the proper processor. The processor using workflow queues can receive work in its electronic “inbox” along with scanned supporting documentation. The processor will attempt to complete the claim but also can electronically communicate to someone in the organization for assistance. The claim can have new status codes assigned, can be denied, or adjudicated. The claims system applies benefits and calculates payments.

Once the claim is finished (adjudicated or denied), the electronic claims payment response is packaged in a standard format and electronically sent to the provider. In addition, the claims payment is sent to the payables system where a check is prepared. Additional documentation is also created called Explanation of Benefits (EOB) and Notification of Payment (NOP).

In a HIPAA related process, as well as other processes, there may be differing levels of data of interest. Typical data levels include, interchange batch level data, transaction set data and claims data. In a further embodiment, the present invention provides information relating to each of these data levels, and provides a user interface that allows a user to easily switch between levels to obtain information of interest.

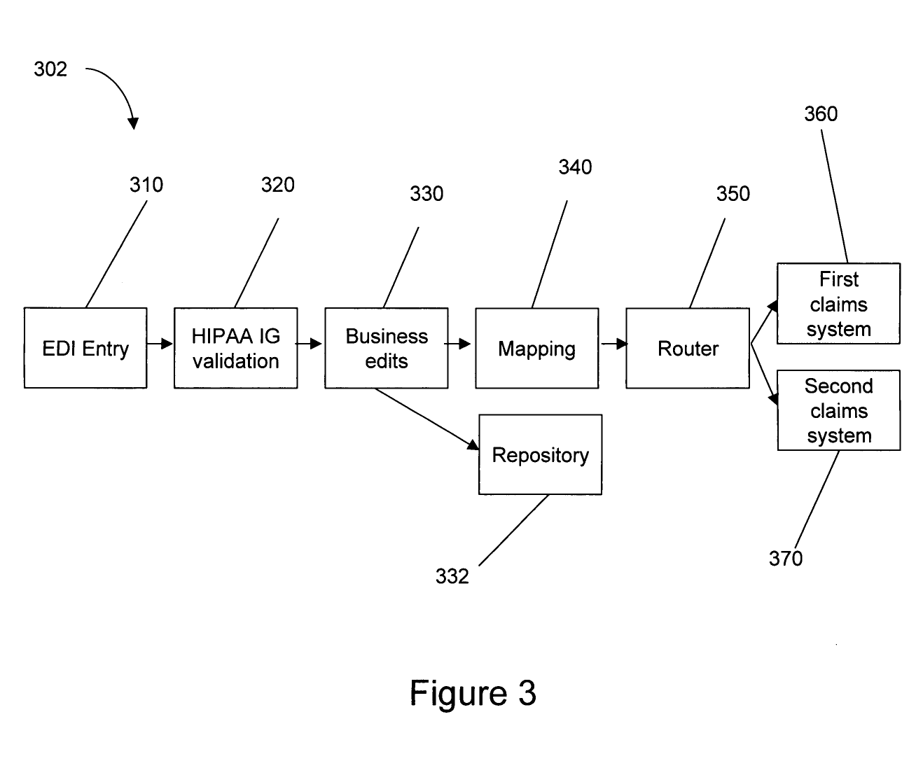

FIG. 3 depicts, in schematic form, the type of processing a health insurance claim may undergo during a HIPAA related portion, 302, of claims processing. It should be appreciated that the process depicted in FIG. 3 is set forth in simplified form for the purposes of illustrating the present invention and that actual claims processing may or may not differ in various aspects.

As shown in FIG. 3, a claim may enter the process through an Electronic Data Interchange (EDI) Entry, 310. A claim then travels through a HIPAA Implementation Guide validation process 320, and then into a business edits process 330, wherein claim data is also transferred to a repository 332. From the business edits process 330 a claim travels through a mapping process 340 and then into a router 350 where it is routed to a first claims system 360, or a second claims system 370.

As will be appreciated by those of ordinary skill in the art, multiple processing events occur during the processes depicted in FIG. 3. An advantage of the present invention is that the present invention provides information relating to the processing events. Examples of the type of information provided include: how did the claim enter the system (e.g., from what source); did the claim pass IG validation; did the claim pass business edits; did the claim make it into the repository; where was the claim routed (e.g., into which claims system), and the like.

An embodiment of the present invention is method for tracking health care claims, comprising the steps of: tagging each claim with a uniform claim identifier that uniquely identifies a claim and enables the claim to be traced through a claim processing system; applying a status code to the claim, for example, “Paid,” “In Suspense,” “Medical Review,” etc.; applying a value added field to the claim wherein the value added field is generated by a value added engine and provides additional information related to the claim, for example, if the claim is a Hospital Outlier Payment claim, Coordination of Benefit (COB) claim, etc.; storing each claim at the claim form level; linking across claims belonging to the same patient for continuous billing situations; linking across claims in a claim control process, (e.g., linking a claim that corrects a first claim); linking outside data sources on common fields (e.g., linking through cross-reference keys that link to the Lawson General Ledger, CDW, HIPAA 837 Incoming Claims Repository (ICR), HIPAA 835 NOP/EOP Remittances, and state data from external sources such as CMS National Claims History or third party health care data vendors).

An embodiment of the present invention is a method for tracking an in-process claim over a communications network, comprising the steps of: querying a specific claim to determine claim location, claim paid status, claim status (e.g., open, closed, in review), paid amounts, charge amounts, COB, utilization, product, place of service, etc.

An embodiment of the present invention also enables queries to group claims, for example, as billed/allowed/paid by practice and/or servicing provider; queries to identify trends of claim payments for people falling within specified demographics (e.g., men, women, age, county of residence); queries to identify trends of payments and overall health for people who comply with suggested courses of treatment or preventative care versus groups who do not; queries to identify claims that may have been paid incorrectly, for example, by associating the queries to denial reason codes or other information to identify potential candidate for adjustment; and queries against a claims database and HIPAA claims data that return accurate data sets to support the actuarial data requirements for risk assessment.

An embodiment of the present invention is a method that comprises the following steps: storing clean claims data in a database; cross referencing the data base to at least one external data source, wherein the external data source includes at least the General Ledger, corporate data warehouse, HIPAA 837 Incoming Claims Repository (ICR), HIPAA 835 NOP/EOP Remittances, or state data from sources such as the CMS National Claims History or third party health care data vendors; applying business rules of valued-added data generated by one or more value-added engines (VAEs); providing logical and physical data structures of a database for claims and accounting data; mapping and transforming clean claims data to the data structure; accessing, mining, and analyzing the data; and producing reports from the database.

An embodiment of the present invention may use the National Claims History (NCH) claims record data structure, or a claims record data structure derived from the NCH. The NCH is used by the federal government of the United States of America. The standard data structure and query protocols of the NCH of the Center for Medicare and Medicaid Services (CMS, formerly HCFA) is a claims record data structure that records and stores the adjudicated claims transactions submitted by providers to payers for the Medicare program.

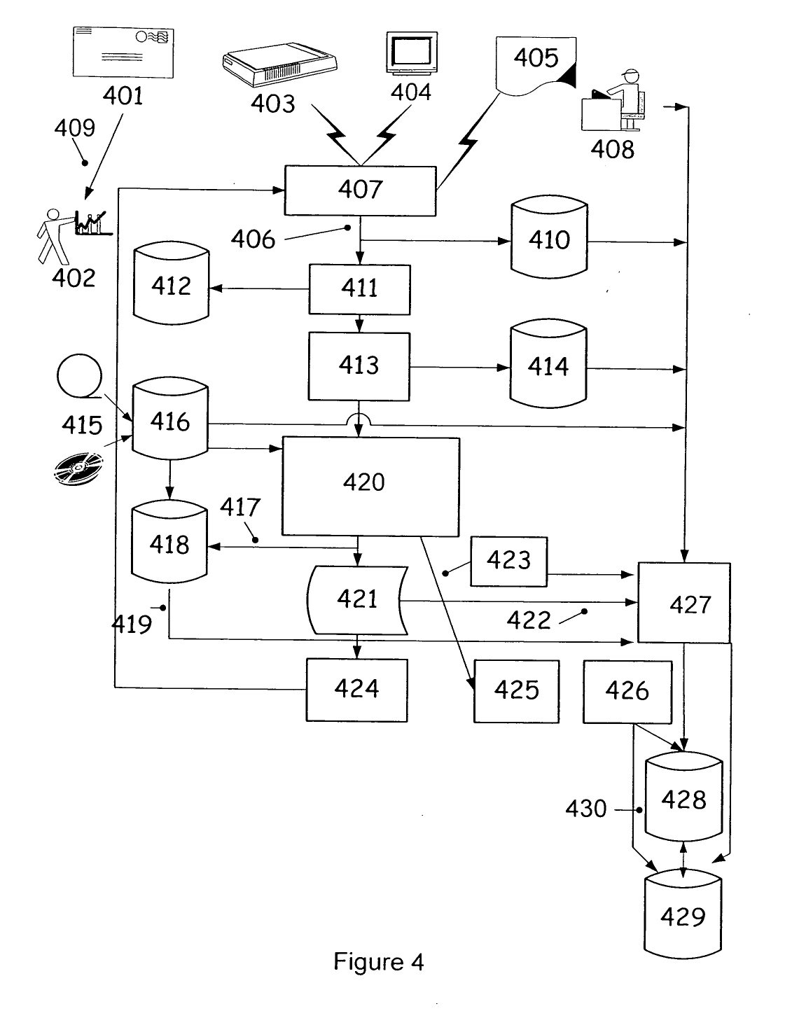

FIG. 4 depicts the mapping and transformation of claim identifiers and cross-reference keys from collaborative systems. For example, cross-reference claim identifier keys 419 from the corporate data warehouse 418 are mapped, transformed and stored to the central database 428, which links the claims and accounting data 430 of the database 428 to the corporate data warehouse 418 and vice versa. Actual paid amounts of claims and the corresponding claim identifier from the Lawson General Ledger is also mapped, transformed and stored in the database 428. Similarly, 835 NOP/EOP cross-reference claim identifier keys, which are mapped to the 837 cross-reference tables of the HIPAA 837 Incoming Claims Repository (ICR) 412, enables users to link the claims and accounting data to claims data stored in the HIPAA 837 ICR 412.

The ability to cross-link claims and accounting data to external data sources in collaborative systems assures that claims data sources are balanced and that differences between data sources can be reconciled. In addition, users of external data sources can access and use the more detailed claims data to support queries and business information needs of the insurance provider.

The arrows of FIG. 4 show the data flow from the following files, databases, inputs, etc.: 401, paper claims sitting in the mailroom; 409, claim counts being tabulated and provided to a claims analysis and risk assessment activity 402; 403, scanned claims; 404, EDI X12/837, ITS and third party vendor claims; 405, 835 NOP/EOP to provider; 408, claims under manual review; 407, secure connection connect mailbox; 406, 837 key to cross-reference files; 411, business edits; 410, HIPAA cross-reference files; 412, HIPAA 837 ICR; 413, UB-92/CMS-1500 and third party vendor claims mapping; 414, copy of local proprietary formats; 415, third party vendor data; 416, operational data store, third party vendor data; 420, claims processing systems; 417, full claim payment extract; 418 corporate data warehouse; 419, corporate data warehouse cross-reference claim ID keys; 421, 835 local proprietary file common file; 424, 835 NOP/EOP validation and remittance processes; 423, actual paid amounts of claims; 422, key to 837 cross-reference files; 427, mappings and transformations to database; 425, general ledger; 426, value added engine(s); 428, database for all claims history and inventory; 429, meta data repository; and 430, data partitions, claim records, and accounting data. The high level data partitions include, for example, intermediary inpatient/SNF claim records, intermediary outpatient claim records, intermediary home health agency claim records, intermediary hospice claim records, carrier claims, DMERC claim records, ITS national claim records, drug claim records (MEDCO), mental health claim records, and dental claim records.

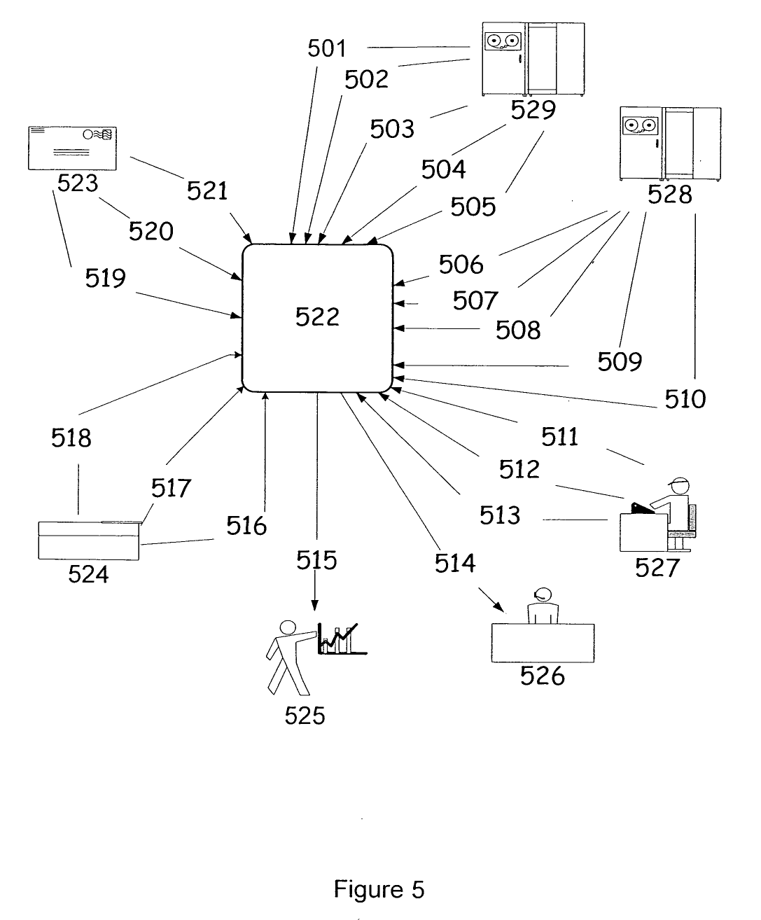

FIG. 5 expresses graphically an embodiment of the present invention. FIG. 5 identifies the domains of interest and related data flows of the data that may be used in a calculation of dollar liability amount and claim counts for claims received but not finally processed for, for example, monthly reserve valuation purposes.

At the center of the work context diagram in FIG. 5 is the collected data, 522, that may be useful in the determination of the dollar liability amount and claim counts for claims received but not finally processed, for monthly reserve valuation purposes. In addition, the diagram identifies the adjacent systems, which represent the domains of interest that supply data that may be useful in UCL estimates 529, 528, 527, 524, 523, or receive information from it 525, 526. These include automated and manual systems and organizational areas. More particularly, the domains of interest that supply data to the process include processed claims but not paid 529, received and scanned claims stuck in front-end router 528, claims manually under review 527, scanned claims remaining in queue 524, and paper claims sitting in the mailroom 523. The domains that receive information are the claims analysis and risk assessment activity 525 which receives “best-in-class” UCL estimates and operations 526 which receives claims throughput reporting 514.

For each month's financial reporting, in an embodiment, the following types of data are extracted and/or reported, split by product and type of service as depicted in FIG. 5: counts of claims and charges received by mail (in mailbags at end of month) additionally split by UB-92 (521), CMS-1500 (520), ITS national claims, and drug, dental and mental health claims (519); counts of claims and charges received and scanned but stuck in scanner “small router” end of month additionally split by UB-92 (518), CMS-1500 (517), ITS national claims, and drug, dental and mental health claims (516); counts of claims and charges for received and scanned “black and white form” claims that remain to be manually keyed into the system at the end of the month split by UB-92 (511), CMS-1500 (512), ITS national claims, and drug, dental and mental health claims (513); counts of claims and charges received and scanned but stuck in “big router” end of month additionally split by UB-92 (506), CMS-1500 (507), Medicare Part-A (NSF6) (509), Medicare Part-B (NSF3) (510), ITS national claims, and drug, dental and mental health claims (508); counts of claims and charges processed but not paid (e.g., in suspense) split by UB-92 (501), CMS-1500 (502), Medicare Part-A (NSF6) (504), Medicare Part-B (NSF3) (505), ITS national claims, and drug, dental and mental health claims (503).

Additionally, the following types of data are extracted and reported, split by product and type of service: counts of claims and charges currently in inventory being manually reviewed (paper claims), not in machine suspense, split by UB-92, CMS-1500, ITS national claims, and drug, dental and mental health claims; and dollar amounts of all claim payments made during the month split by UB-92, CMS-1500, Medicare Part-A (NSF6), Medicare Part-B (NSF3), ITS national claims, and drug, dental and mental health claims.

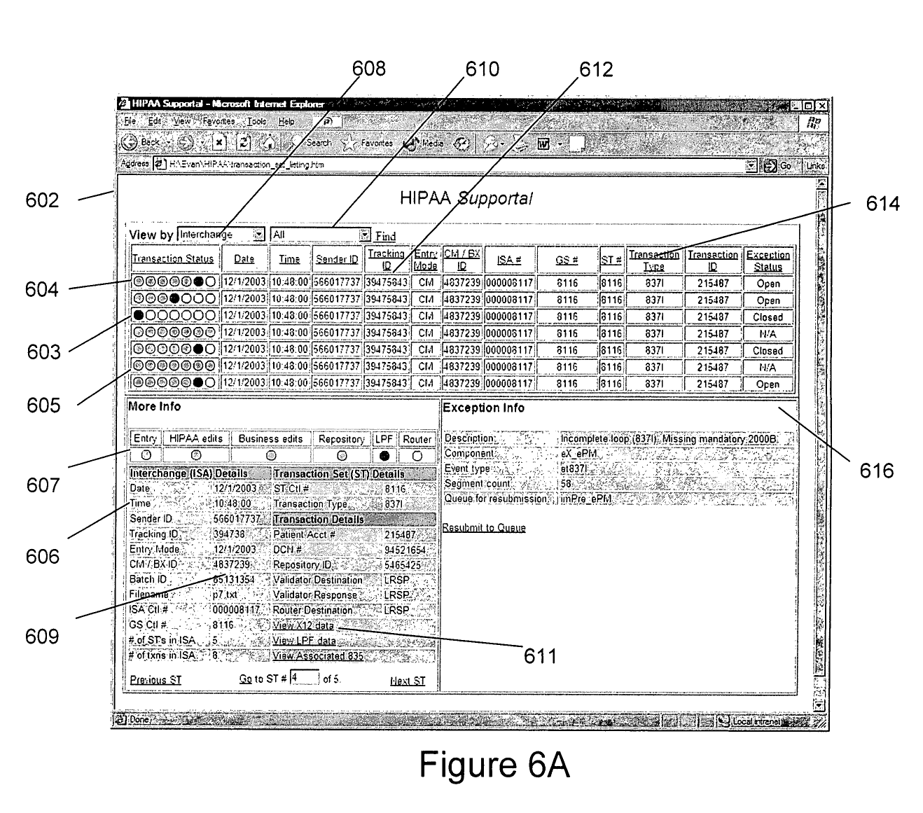

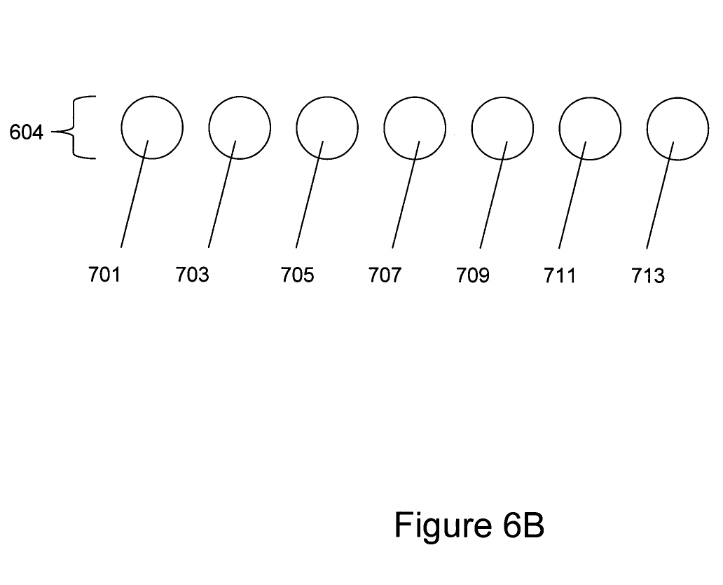

In an embodiment of the present invention, the foregoing types of information, and other information related to a claim set forth herein may be displayed through a user interface display such as depicted in FIGS. 6A, 6B, 7 and 8.

FIG. 6A depicts a display screen 602. The display screen 602 may comprise icons, such as transaction status icons in rows 603, 604 and 605; alphanumeric data displays, 606, 612, and 614; and drop down menus 608 and 610. The data displays may be linked to other displays as shown by alphanumeric data display 614. The display screen may include tiled sections, each with differing data, as represented by tiled section 616.

The transaction status icons 604 comprise circular icons that may be filled with a different color to provide an analog display that, at a glance, will be intuitively understood by a user. In display screen 602, each status icon generally corresponds to a processing step depicted in FIG. 3.

FIG. 6B depicts a row of icons 604, from display screen 602, in greater detail wherein: Icon 701 provides information relating to the EDI Entry 310, in FIG. 3; Icon 703 provides information relating to the HIPAA IG validation 320, in FIG. 3; Icon 705 provides information relating to the Business Edits 330, in FIG. 3; Icon 707 provides information relating to the Repository 332, in FIG. 3; Icon 709 provides information relating to the Mapping, 340, in FIG. 3; Icon 711 provides information relating to the Router 350, in FIG. 3; and Icon 713 provides information relating to the claims system 302, 360 and 370, in FIG. 3.

Each icon, 701 to 713 may provide information relating to status. The status may be indicated through the use of different colors, such as, red, yellow and green colors that may be quickly and intuitively understood by a user. For example, a green colored icon may indicate the processing by the particular processing step been completed without errors. A red colored icon may be used to indicate that processing in the particular step has been halted, for example due to an error. A yellow colored icon may be used to indicate a neutral status, for example that processing has not begun, or processing has begun and is not complete.

Referring again to FIG. 6A, alphanumeric data table display 606, provides more information on a particular claim, or batch of claims depicted in a transaction status icon row, such as row 604. Alphanumeric data table display 406 may include transaction status icons, 607, in a form similar to row 604, as well as alphanumeric data, 609. Display 606 may further include links 611, to additional tables.

Drop down menus 608 and 610 in display 602, may be linked to commands that present the data in different ways. For example, menu 610 could provide commands for filtering the display to display “All” claims or batches of claims as depicted in FIG. 6A, as well as a command for displaying information to filter the display and display only claims with errors. Alphanumeric data 612, may provide data relating to a claim, or batch of claims, such as the tracking identification. Alphanumeric column heading 614, in display screen 602 may be linked to commands that sorts or reformats the data in the particular column, for example by changing the order. Tiled screen 616 may provide information relating to a particular event, for example an event where an error occurred and may be generated through a link to data displayed elsewhere in data display 602.

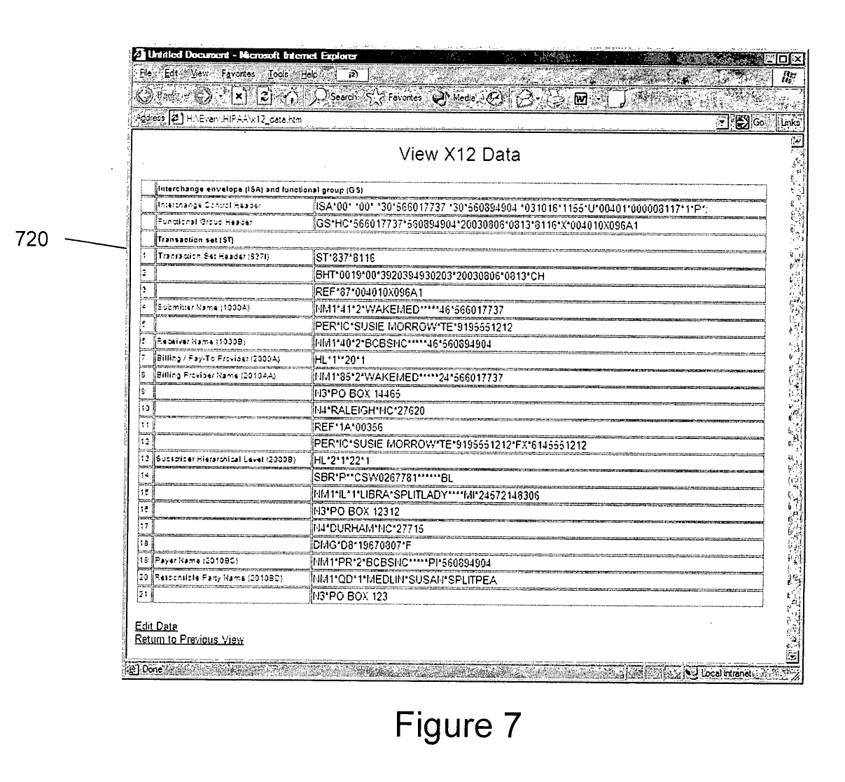

FIG. 7 provides an expanded view of a data screen 720 that may be linked from a data display screen like the one shown in FIG. 6A, for example through link 611 in display screen 602. The data in FIG. 7 is presented in tabular format and provides data relevant to a determination of detailed claim status and/or troubleshooting of processing errors.

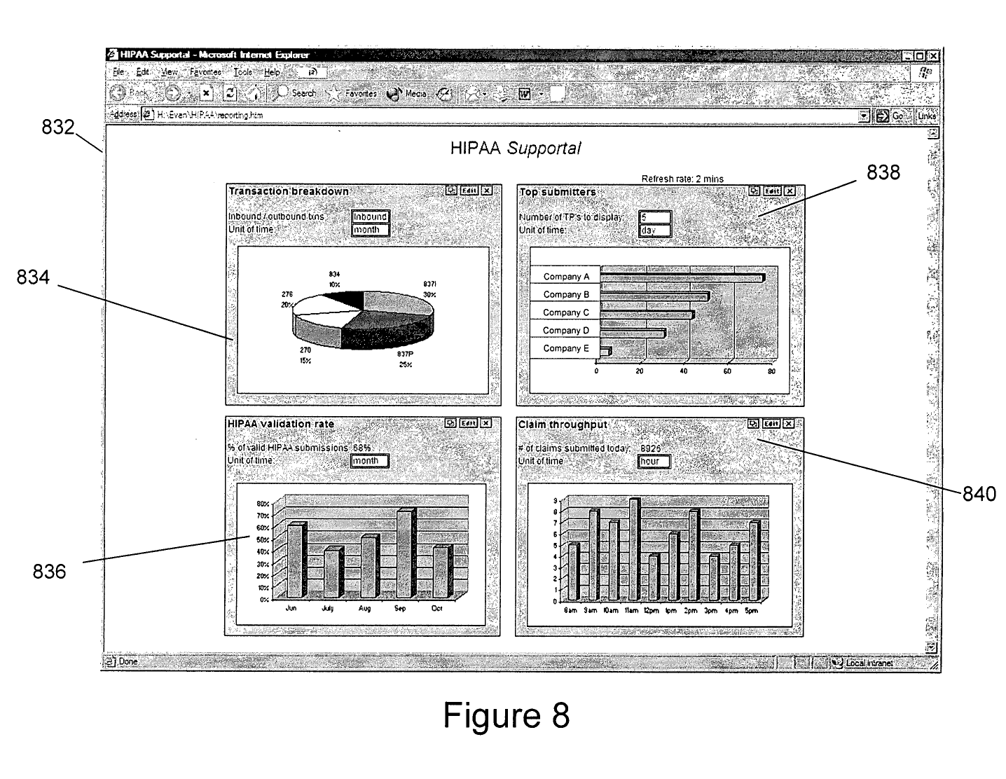

FIG. 8 provides a view of a data display screen 832 wherein data is displayed in graphical form. As shown in FIG. 8, various forms of graphs, such as a pie chart 834 and bar graphs, 836, 838 and 840 may be used to provide visual feedback such as summarizing claim status. The graphs may be tiled as shown in FIG. 8.

As will be appreciated through a review of FIGS. 6A, 6B, 7 and 8 a user interface of the present invention has many advantages. A user interface may provide status information in substantially real time. Further, the icons in a user interface of the present invention may be quickly and intuitively understood, thereby increasing the efficiency of a user. Similarly, the graphs, and graphical data displays, provide direct visual feedback on the processing status. In addition, background data and information may be linked for troubleshooting, auditing and similar purposes.

Further, a user interface of the present invention allows the presentation of data to be tailored for particular audience needs. For example, particular charts and bar graphs may be used to present summary type data relevant to a manager, or detail data relevant to a processor. Further, data may be presented at a high level with internal user interface links to detailed data.

As will be appreciated by those of ordinary skill in the art, embodiments of the present invention may be implemented using operational/transactional data relating to a claim. An embodiment of the present invention uses operational/transactional data to identify and define claims and accounting data, the characteristics of the data, and the roles the data play with other data. For example, operational/transactional data for the present invention includes the name of the data captured and extracted from claim data sources, business description of the data, the extraction, transformation and load methods used to populate a database, the definition of the data contents, the date of creation, the name of the data source, operational metrics regarding freshness of the data and processing times. In addition, the operational/transactional data describe the “business rules” used by the Value-Added Engine(s) to generate instances of value-added data fields and a history of what business rules were in fact applied to the particular claim in question.

In an embodiment of the present invention, several types of operational/transactional data are managed. For example, each claim and accounting data source is characterized by a unique format and the data fields may have their own set of definitions. Processes that add time stamps and create uniform claim identifiers to claim data use operational/transactional data about the incoming data to manage the data mapping and transformation. The major types of operational/transactional data that are managed are as follows: standard data definitions including the technical definitions and business descriptions for business intelligence applications; operational/transactional data captured and created in the refinement of the claims and accounting data sources; operational/transactional data on granularity, partitions, subject areas, aggregation, and summarization; operational/transactional data describing pre-defined queries and reports; operational/transactional data describing indexes and profiles that improve data access and retrieval performance; and operational/transactional data describing the rules for timing and scheduling the refresh, update and replication cycle of the data in the claim processing system.

Embodiments of the present invention have now been described in fulfillment of the above objects. It will be appreciated that these examples are merely illustrative of the invention. Many variations and modifications will be apparent to those skilled in the art.

That which is claimed:

1. A method for automated in-process tracking of an item that is being processed through an operation, comprising the steps of:
receiving a first datum associated with the item;
identifying the item with a uniform identifier that uniquely identifies the item and allows the item to be traced through the operation;
receiving a second datum associated with a first event, wherein the first event results when the item is processed by a first application;
populating a database with the first datum and the second datum;
associating a status code to the item;
generating an alert relating to the item; and
communicating the alert through a communications network to a computing device in-process information about the item
wherein the first and second datum persist in the central database.

2. The method of claim 1 further comprising:
generating escalation information relating to the item; and
communicating the escalation information through the communications network to the computing device.

3. The method of claim 1 further comprising:
communicating in-process information about the item to the computing device through the communications network in response to a query of the database.

4. The method of claim 1 further comprising:
generating with a value added engine at least one value added field that provides descriptive information about the item.

5. The method of claim 1 wherein the first item is an insurance claim.

6. The method of claim 2 wherein the first item is an insurance claim.

7. The method of claim 3 wherein the first item is an insurance claim.

8. The method of claim 4 wherein the first item is an insurance claim.

9. The method of claim 1 further comprising a plurality of additional datum associated with the first event, the second event, or one or more additional events; and
populating the database with the additional datum.

10. The method of claim 3, wherein in-process information regarding the item provides data for an unpaid claims liability calculation.

11. The method of claim 5, wherein the first datum comprises data relating to: identity of an insured, identity of a provider of services to the insured, benefits available to the insured, costs of services, location of services, a diagnosis, or a procedure.

12. The method of claim 1, wherein the first event comprises a change in the status, a change in location, or a transformation.

13. The method of claim 1, wherein the first application comprises a routing application or an adjudication application.

14. The method of claim 1, further comprising the step of receiving a third datum associated with a second event, wherein the second event results when the item is processed by a second application.

15. The method of claim 14 wherein the first application is different than the second application.

16. The method of claim 1, wherein the computing device comprises a user interface that graphically displays information about the operation.

17. An automated system for in-process tracking of an item that is being processed through an operation, comprising:
a processor;
wherein the processor identifies an item with a uniform identifier that uniquely identifies the item and allows the item to be traced through the operation;
a database;
wherein the database is populated with a first datum associated with the item;
wherein the database is populated with a second datum associated with a first event, wherein the first event results when the item is processed by a first application;
and wherein the first and second datum persist in the database;
an alerting mechanism
wherein the alerting mechanism generates an alert relating to the item; and
a server communicatively coupled to at least one remote computing device for providing in-process information about the item in response to a query of the database

18. The system of claim 17 further comprising:
an escalation mechanism, wherein the escalation mechanism generates escalation information relating to the item.

19. The system of claim 17 further comprising:
a value added engine, wherein the value added engine generates at least one value added field that provides descriptive information about the item.

20. The system of claim 17, wherein the first item is an insurance claim.

21. The system of claim 17, wherein the database is populated with a third datum associated with a second event, wherein the second event results when the item is processed by a second application.

22. The system of claim 21 wherein the first application is different than the second application.

23. The system of claim 17, wherein the computing device comprises a user interface that graphically displays information about the operation.

24. A method for automated in-process tracking of insurance claims for use in estimating unpaid claims liability, comprising the steps of:
identifying an insurance claim with a uniform identifier that uniquely identifies the claim and allows it to be traced through the claim processing operation;
receiving a first datum associated with a first event, wherein the first event results when the claim is processed by a first application;
receiving a second datum associated with a second event, wherein the second event results when the claim is processed by a second application;
wherein the first application is different than the second application;
populating a database with the first datum and the second datum;
associating a status code to the insurance claim;
communicating through a communications network to a computing device in-process information about the claim in response to a query of the database.
